(19) United States
(12) Patent Application Publication
(10) Pub. No.: US 2013/0112150 A1
(43) Pub. Date: May 9, 2013

(54) LIGHTWEIGHT ABSORBENT CELLULOSE PELLETS

(71) Applicant: ABSORPTION CORP., Ferndale, WA (US)

(72) Inventors: Douglas E. Ellis, Ferndale, WA (US); Doug Seekins, Jesup, GA (US); Bill Gunter, Ferndale, WA (US); Sara McDonald, Ferndale, WA (US)

(73) Assignee: ABSORPTION CORP., Ferndale, WA (US)

(21) Appl. No.: 13/673,831

(22) Filed: Nov. 9, 2012

Related U.S. Application Data
(60) Provisional application No. 61/557,617, filed on Nov. 9, 2011.

(51) Int. Cl. A01K 29/00

(52) U.S. Cl. CPC A01K 29/00
USPC 119/172; 264/141; 502/404

(57) ABSTRACT

An absorbent material which may be used for animal bedding or litter, is made up of pellets of cellulosic fiber having a bulk density of 95 to 350 kg/m³. The cellulosic fiber may be reclaimed from the waste stream of a paper product manufacturing. The pellets may have a diameter of 3 to 12 mm and a length of 3 to 36 mm. For use as a cat litter, the pellets may have a density of 240 to 305 kg/m³ For use as a small animal litter, the pellets may have a density of 160 to 225 kg/m³. The pellets have a very low amount of inorganic material, typically less than 10% or less than 5% by weight.

### CROSS-REFERENCE TO RELATED APPLICATIONS

This application claims the benefit of U.S. Provisional Patent Application No. 61/557,617, filed Nov. 9, 2011, which is incorporated herein by reference.

### BACKGROUND OF THE INVENTION

The field of the invention is lightweight absorbent materials as used for small animal bedding and litter materials.

Flowable litters are granular materials such as wood pellets, paper pellets, ground corn cob and chipped pulp sheets. Flowable litters are especially useful for applications where the animals live on top of the substrate, as opposed to small mammals that burrow and nest under the material. Flowable litters are typically relatively hard and dense materials, with low absorptive speed and capacity by weight. Although these types of products generally flow well through professional automated dispensing equipment, they typically cannot absorb liquid waste as effectively as other materials.

Wood shavings and pellets have been used for small animal bedding or litter materials. However, these may contain irritants such as natural aromatic oils, and also have potential ingestion and abrasion health risks for small animals. Pulp and paper-based pellet litters have also been similarly used. However, these materials generally contain inorganic or clay filler materials as a binder and/or clumping agent. These materials also tend to be heavy, can absorb only limited quantities of liquid and lose mechanical integrity when wet.

Accordingly, improvements in flowable small animal bedding and litter are needed.

### SUMMARY OF THE INVENTION

An absorbent material, which may be used for animal bedding or litter, is made up of pellets of cellulosic fiber having a bulk density of 95 to 350 kg/m³ (6 to 22 lbs/ft3) and a very low amount of inorganic material. The cellulosic fiber may be virgin fiber, reclaimed fiber, recycled fiber, or combinations of these. For example, the cellulosic fiber may be provided from the waste stream of a paper product manufacturing facility. The pellets may have a diameter of 3 to 12 mm and a length of 3 to 36 mm. For use as a cat litter, the pellets may have a density of 240 to 305 kg/m³ (15 to 19 lbs/ft3). For use as a small animal litter, the pellets may have a density of 160 to 225 kg/m³ (10 to 14 lbs/ft3).

A method for making absorbent cellulose pellets includes providing a mixture of cellulose fiber in water with the cellulose fiber comprising 20% to 60% by weight of the mixture, and with the mixture containing less than 15% by weight of inorganic materials. The mixture is introduced into a pellet forming machine and formed into a cylinder or string. The string is cut to form the pellets, and the pellets are dried. The pellets may have less than 5, 3 or 1% of inorganic material by weight.

The invention resides as well in subcombinations of the composition and methods described.

### BRIEF DESCRIPTION OF THE DRAWINGS

FIG. 1 is a flowchart illustrating a method of the invention.

FIG. 2 is a side view in part section of the pellet mill shown in FIG. 1.

FIG. 3 is an enlarged diagrammatic view of operation of the pellet mill shown in FIG. 2 showing how the cellulose pulp is compressed and shaped as it passes through the pellet mill.

FIG. 4 is a graph of linear regression of water in the ingoing source material graphed against the resultant bulk densities of the dry pellet end product.

FIG. 5 is a diagrammatic view of a pellet as formed via the process shown in FIG. 1.

### DETAILED DESCRIPTION

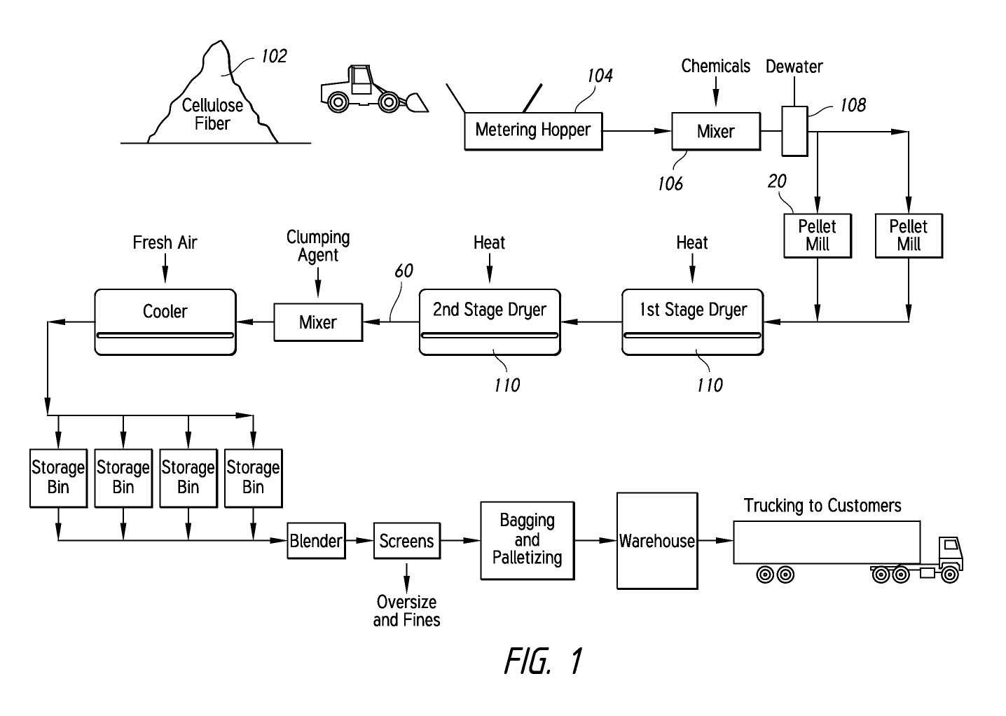

Referring to FIG. 1, a wide variety of virgin, reclaimed, and recycled cellulose fiber from varied sources can be used to make the pellets. These source materials should have an inorganic content of no more than 20% by weight, but preferably no more than 5%, 3% or 1% inorganic solids. The source material used contributes to the physical and qualitative characteristics of the resulting end product pellets.

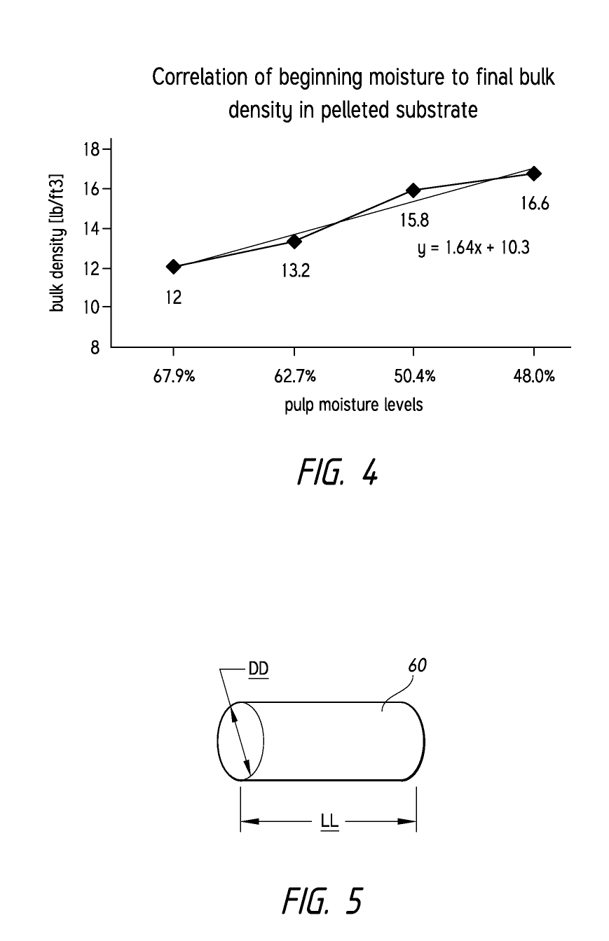

FIG. 1 shows an example of bulk cellulose fiber 102 provided to a metering hopper 104, then to a mixer 106 and a dewatering apparatus 108. The cellulose fiber may alternatively be provided in a slurry, such a slurry from the waste stream of a paper product manufacturing facility. In either case the cellulose fiber source material is processed to adjust water content based on the desired finished pellet density. This may be achieved by adding or removing water from the source material. As shown in FIG. 4, decreasing moisture content of the source cellulose material was found to correlate strongly with increasing bulk density in the finished pellets.

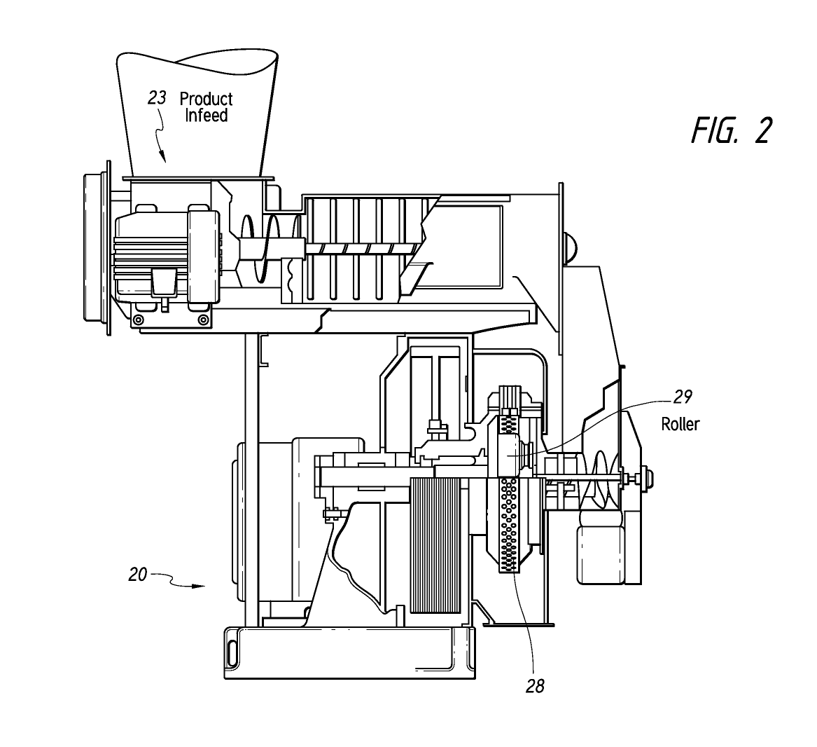

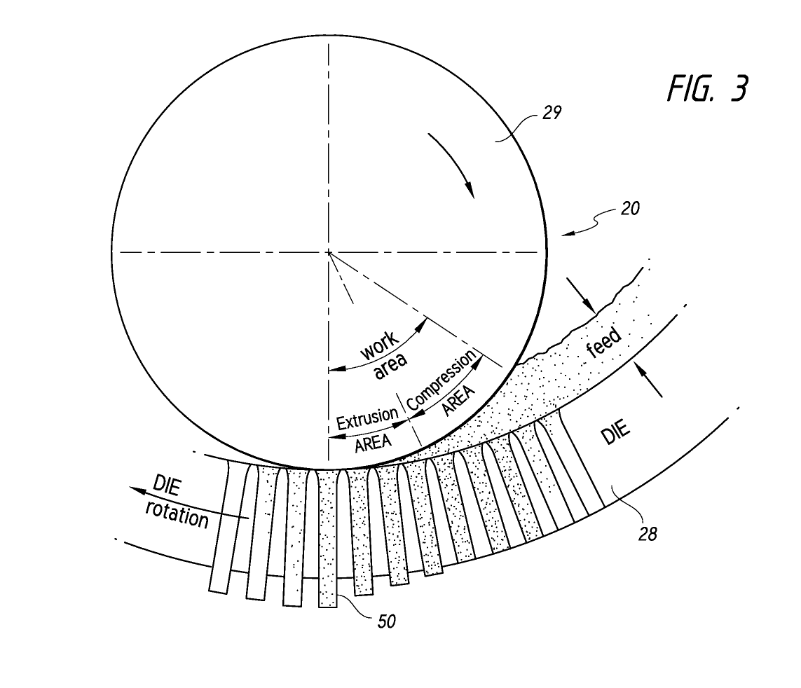

The cellulose source material is mixed with water with the cellulose material making up 20-60% by weight of the mixture, and with water making up the balance. The material is then conditioned to form fiber bundles, typically about 25 mm or smaller. The fiber bundles are fed into a high pressure rotating die pellet mill 20. Referring now also to FIGS. 2 and 3, in the mill 20, the material is forced through a thick, perforated die 28 having through holes of a specified diameter. A pellet string 50 is continuously forced out of the holes in the die 28 via a roller 29 interacting with the die 28. The pellet string is cut to form pellets.

Where the source material as provided into the mill 20 contains a high fraction of water, for example with the cellulose material making up 20 to 30 or 40% by weight, the strength of the pellet string may become a factor. Specifically, when the source material is so wet, the material coming out of the mill 20 may be unable to hold its shape, preventing formation of pellets. Although the specific minimum cellulose fraction useable will vary depending on other characteristic of the source material, in general source materials with at least 18 or 20% by weight of cellulose can be reliably formed into pellets.

Both flat die and circular die pellet mills can be used with dies having plate depth to whole size ratio ranging from about 1:3 to about 1:17. The die holes can be counter sunk, with the counter sink diameters touching at the surface, for improved through put. Dies tested were patterned at 14×128 for 6 mm CA inch) and 24×240 for 3 mm (⅛ inch) holes. The die may also be cut in a variety of tapers for controlling pressures in the forming area. The specific example shown in FIG. 2 is a Round Vertical Rotating Die Pellet Mill available from California Pellet Mills, Crawfordsville, Ind., USA. Alternatively, pressure screw extruders may be used instead of a pellet mill.

Referring back to FIG. 1, the resulting wet-formed pellets are collected and dried in dryers 110, for example, by uniformly placing them by way of swept surface conveyor into a multi-pass belt type dryer. Other similar types of dryers, such as fluidized bed dryers, may alternatively be used. Optimal dryer temperature is between 120 to 180° C. (250 to 350)° F., or between 135 to 150° C. (275 to 300° F.). The final moisture content of the pellets may be 2 to 10% or 6 to 8%. Over drying the product should be avoided as this can collapse the cellulose fibers/fibrils, thereby inhibiting moisture wicking and absorption.

As further shown in FIG. 1, the dried pellets 60 are cooled and optionally stored, blended, screened, and packaged. A clumping agent may be added in specific embodiments between the drying and cooling steps. Similarly, wetting agents, odor control agents, dust control agents, and binders may be added in the process before or after the material is fed into the pellet mill 20. Dry surface active agents may be dusted or tumbled onto the pellets while wet and prior to drying, or after partially dried. Wet surface active agents may be sprayed or misted onto the pellets at any time during production.

FIG. 5 schematically shows a pellet 60 manufactured as described above and having a length LL typically about 3 to 36 mm (⅛ inch to 1½ inch) and a diameter (or other characteristic dimension) ranging from about 3 to 12 mm in diameter. The pellets may have a density of 95 to 350 kg/m³ depending on the ratio of cellulose to water in the material going into the mill 20.

Using a source material having a high water content results in pellets having low density with a large amount of internal surface area. This provides for greater absorption speed and holding capacity, as well as enhancing the activity and availability of any additives embedded within the cellulose matrix. The pellets have a high porosity, an easily-adjustable target density, and excellent absorbency. The pellets also have a very low degree of dusting and retain their structure very well when wetted, wicking liquid into pores within the cellulose pellets.

The cellulose pellets also work well for clumping litter applications because they have a porous and rough external surface which particulate clumping agents may easily adhere to without using adhesives or binders.

Inorganic materials typically present in cellulose waste streams used to provide the source material may include clay, calcium, rocks, minerals, gypsum, etc. Some waste streams have high concentrations of these types of inorganic materials. These inorganic materials degrade the final litter or bedding product and should be minimized to less than 10%, 5% or 3% by weight of the pellets.

### Example No. 1

Pellets for small animal bedding were produced using the following process:

a) Start with a short fiber stream having minimal inorganic materials.
b) A fiber suspension in water was prepared with the fiber comprising 0.1% to 8% of the suspension by weight.
c) The fiber suspension was mixed until uniform.
d) The suspension was dewatered to 22% solids in a dewatering press.
e) The dewatered solids were formed into a press cake and the press cake was broken into clumps of about 50 mm (2 inches) or less.
f) The clumps were placed into a horizontal pellet mill with a die having holes 3 mm (⅛ inch) in diameter. The dewatered solids forming the clumps were pressed into pellet strings.
g) The pellet strings were cut to approximately 3 to 12 mm (⅛ to ½ inch) lengths.
h) The pellets were collected and dried via forced air drying.

The pellets produced had a bulk density of 216 kg/m3 (13.5 lbs/ft3). The pellets had a soft, coarse, sand like texture. Small animal application testing showed the pellets were suitable for mice, rats, gerbils and other small animals. The pellets were not used by the animals for nesting. Rabbits and guinea pigs could easily kick the pellets into piles and out of the cage due to its size and light density. Upon cleaning the cages the soiled pellets did not stick to the cage bottom. Dust levels were tested to be lower than corn cob-based products. The pellets were flowable. Testing on a wide variety of different automated feeding systems showed compatibility with this type of cage filling equipment.

Step (b) of Example No. 1 forms a dilute slurry of source material, which may be used to purify the source material and/or to add chemical additives, or it may also be omitted entirely, with the source material fed into the mill 20 without forming a slurry. In step (e), a flocculant may be added to cause the fibers to form into bundles.

### Example No. 2

Using the process steps outlined in Example No. 1 above, a bleached Kraft softwood pulp was dewatered to 32% solids and formed into pellets using a die plate having 6 mm (0.25 inch) holes. The resultant dried pellets were 6 mm in diameter by 9 mm long with a density of 128 kg/m3 (8 lbs/ft3). The pellets were flowable, although not as flow able as the pellets of Example No. 1. The pellets were soft to the touch and retained a clean, bright white color. Testing under live animals showed the pellets were suitable for environmental enrichment and the nesting needs of gerbils, hamsters and mice.

### Example No. 3

Using the process of Example No. 2 above, waste fiber from a de-inked news print mill was used at 52% solids content. The resulting product was dark grey and had a bulk density of 240 kg/m3 (15 lbs/ft3), and a lower dust level than corn cob. The dark gray color was thought to be less desirable than the product of Example No. 1 and the materials used had significant impurities including printing inks, printing oils, inorganic calcium and clays. The inorganic content of the resulting product was about 32%. There was also a slight undesirable odor to the product.

### Example No. 4

Using the process of Example No. 3 above, the product was captured after step (h) and run through a set of pinch rolls set to a 3 mm tolerance. The resulting product was a flattened particle approximately 9 mm wide and 19 mm long. The product had a density 208 kg/m3) (13 lbs/ft3). The flat product produced under this method was softer and did not roll under animal's feet such as the product of Example No. 3. This feature was seen as beneficial by some end users in a controlled test.

### Example No. 5

Using the process of Example No. 1, a 1% water based solution of food safe turquoise blue dye was sprayed onto the product between steps (g) and (h) while tumbling the product in a cement mixer. Then the product was dried. The resulting product was a vivid bright turquoise material thought to be visually pleasing for home use applications.

### Example No. 6

Using the process of Example No. 1, a 1% solution of carboxymethyl cellulose was lightly sprayed onto dry pellets, and the pellets were then dusted with 3% by weight industrial grade fine mesh powdered guar. The resulting product formed a high-performing clumping cat litter.

### Example No. 7

Using the process of Example No. 1, dried 3 mm cellulose pellets were passed through a flaking mill to make smaller absorbent particulate, suitable for cat litter and other applications. The resulting particulate possessed a soft, sand-like texture and greatly increased surface area. The flaked particulate functioned very well as a clumping litter when coated with dry surface active agents.

As a non-clumping cat litter the cellulose pellets are lightweight, small enough to sieve through common cat litter strainers and excellent at absorbing waste to control odors. As a clumping cat litter, the cellulose pellets are lightweight, small enough to sieve through common cat litter strainers and excellent at encapsulating waste to control odors. A similar litter for dogs may use a larger-sized, lightweight paper pellet, which is softer and more absorbent. Another similar lightweight, highly-absorbent, and biodegradable product may be used for small mammal, bird, and reptile litter. This product may be easily flowable for use in automated litter dispensing units as typically used with laboratory animals. Dyes, antimicrobial agents, or scents may be added to any of the products.

Thus multiple embodiments and methods have been shown and described. Various changes and substitutions may of course be made without departing from the spirit and scope of the invention. The invention, therefore, should not be limited, except by the following claims and their equivalents.

1. An absorbent material comprising:
pellets comprising cellulose fiber and having a bulk density of 95 to 350 kg/m³ (6 to 22 lbs/ft3) and less than 15% by weight of inorganic material.

2. The material of claim 1 with the cellulose fiber comprising virgin fiber, reclaimed fiber, recycled fiber, or a combination of them.

3. The material of claim 1 with the pellets having an absorptive capacity of 1.0 to 3.5 times the dry weight of pellets.

4. The material of claim 1 with the cellulose fiber provided from a waste stream of water and cellulose fiber from a paper product manufacturing facility.

5. The material of claim 1 further including clumping additive which causes the pellets to clump together when contacted with animal urine.

6. The material of claim 1 further including one or more of a dyes, surfactants, odor control agents, dust control agents, binders, adhesives, anti-microbial agents, and scenting agents.

7. The material of claim 1 with the pellets having substantially the same length and diameter.

8. The material of claim 7 with the pellets having diameter of 3 to 12 mm and a length of 3 to 36 mm.

9. The material of claim 1 with the pellets having a density of 160 to 290 kg/m³.

10. The material of claim 1 comprising a cat litter with the pellets having a density of 240 to 305 kg/m³ (15 to 19 lbs/ft3).

11. The material of claim 1 comprising a small animal litter with the pellets having a density of 160 to 225 kg/m³ (10 to 14 lbs/ft3).

12. The material of claim 1 comprising animal litter with the pellets having a density of 160 to 290 kg/m³ (10 to 18 lbs/ft3).

13. The material of claim 1 with the pellets having less than 5% of inorganic material by weight.

14. The material of claim 1 with the pellets having less than 3% of inorganic material by weight.

15. A method for making absorbent cellulose pellets, comprising:
providing a mixture of cellulose fiber in water with the cellulose fiber comprising 20% to 60% by weight of the mixture, and with the mixture containing less than 15% by weight of inorganic materials;
introducing the mixture into a pellet forming machine;
forming the mixture into extruded cylinders;
cutting the cylinders to form pellets; and
drying the pellets.

16. The method of claim 15 with the pellets having less than 5% inorganic materials.

17. The method of claim 15 with the pellets having a density of 160 to 290 kg/m³ (10 to 18 lbs/ft3).

18. The method of claim 15 further including providing the mixture of cellulose fiber in water by collecting a waste stream from a paper product manufacturing facility.

19. The method of claim 18 further including adding water to the waste stream to form a pre-mixture of water and cellulose with the cellulose comprising 0.1 to 10% by weight, and adding a chemical additive to the pre-mixture, and then de-watering the pre-mixture.

20. The method of claim 15 further including resizing the pellets to smaller particulate forms by grinding, crushing, fracturing, cracking, flaking or milling.

21. The method of claim 15 further comprising forming the cellulose fiber into fiber bundles before introducing the cellulose fiber into the palletizing machine.

22. A method of making a small animal litter or bedding material, comprising:
providing a fiber stream of any combination of virgin, reclaimed, or recycled cellulose fiber;
mixing the fiber stream with water to produce a suspension wherein the fiber comprises 1% to 15% of suspension by weight;
dewatering the suspension to a range of 20 to 60% solids by weight;
forming the resulting material into a pellet string having a diameter of 3 to 12 mm;
cutting the pellet string into pellets 5 to 40 mm long; and
drying the pellets, with the pellets having a density of 160 to 290 kg/m³ (10 to 18 lbs/ft3).
